(19) United States
(12) Patent Application Publication
(10) Pub. No.: US 2023/0166956 A1
(43) Pub. Date: Jun. 1, 2023

(54) METHOD FOR FILLING AN OPERATING FLUID CONTAINER AND OPERATING FLUID CONTAINER FOR CARRYING OUT THE METHOD

(71) Applicant: KAUTEX TEXTRON GmbH & Co. KG, Bonn (DE)

(72) Inventors: Steffen BENDEN, Bornheim (DE); Yunqing YU, Koln (DE); Eric McGRAW, Koln (DE); Stefan WIND, Hennef (DE)

(21) Appl. No.: 18/070,273

(22) Filed: Nov. 28, 2022

(30) Foreign Application Priority Data
Nov. 29, 2021 (DE) 102021213449.1

(51) Int. Cl. B67C 3/28; B67C 3/26

(52) U.S. Cl. CPC B67C 3/283; B67C 3/26; B67C 3/286; B67C 2003/2602

(57) ABSTRACT

A method for filling an operating fluid container and the operating fluid container thereof, which allows gases expelled from the operating fluid container to the atmosphere during a filling process of the operating fluid container to be reduced.

The present invention relates to a method for filling an operating fluid container. Furthermore, the present invention relates to an operating fluid container for carrying out the n method. Furthermore, the invention relates to a motor vehicle which has the operating fluid container.

During the process of filling an operating fluid container by means of a filling device designed, for example, as a nozzle, the operating fluid container must be vented on account of the gases expelled from the operating fluid container interior, so that the operating fluid container can be filled unhindered. In the case of an operating fluid container designed, for example, as a fuel container, the gases expelled into the atmosphere are loaded with hydrocarbons from the fuel.

It is known from the prior art to provide a recirculation line which fluidly connects the interior of an operating fluid container to the filling pipe, in order to reduce the gases expelled from the operating fluid container. During a filling process, by providing an appropriately arranged recirculation line, part of the gases expelled from the operating fluid container is con-ducted via the recirculation line into the filling pipe, so that less ambient air is drawn into the operating fluid container during the filling process.

With this operating fluid container known from the prior art, however, there is still the problem that, depending on the filling rate, i.e. the amount of operating fluid filled into the operating fluid container per unit of time, a significant amount of gas expelled from the operating fluid container reaches the atmosphere either via the vent line or via the filling pipe.

The object on which the present invention is based is that of providing a method for filling an operating fluid container that allows gases expelled from the operating fluid container to the atmosphere during a filling process of the operating fluid container to be reduced.

The object of the present invention is achieved by a method having the features of claim 1. Advantageous embodiments of the method are described in the claims dependent on claim 1.

In more detail, the object on which the present invention is based is achieved by a method for filling an operating fluid container, wherein the operating fluid container has at least one operating fluid container interior which can be filled with an operating liquid via a filling pipe, and wherein the operating fluid container interior is fluidly connected to the filling pipe by means of a recirculation line, and wherein the operating fluid container has an electrically controllable valve which is arranged in the recirculation line and is adjustable between an open position and a closed position, and wherein the operating fluid container has a vent line which at least indirectly fluidly connects the operating fluid container interior to the atmosphere. The method comprises the following method steps:
determining a filling rate during a filling process of the operating fluid container;
determining a target degree of opening of the electrically controllable valve on the basis of the filling rate; and
setting the degree of opening of the electrically controllable valve to the target degree of opening.

The method according to the invention has the advantage that the amount of air charged with gaseous components of the operating fluid that is expelled from the operating fluid container to the atmosphere or to an activated carbon filter device during a filling process is reduced. This is because, by controlling the degree of opening of the electrically controllable valve, the gas volume flow expelled from the operating fluid container, which is fed from the operating fluid container interior via the recirculation line and via the filling pipe back into the operating fluid container interior, can be controlled on the basis of the filling rate at which the operating fluid container is filled with operating fluid, such that a minimized amount of fresh ambient air is sucked into the operating fluid container via the filling pipe, and that a minimized amount of gas expelled from the operating fluid container is discharged via the vent line to the atmosphere or to an activated carbon filter device which is fluidly connected to the operating fluid container interior by means of the vent line, and that an amount of gas expelled to the atmosphere via the filling pipe is minimized.

The operating fluid container is, for example, an operating fluid container to be installed in a motor vehicle. The operating fluid container can be designed, for example, as a motor vehicle tank. Furthermore, the operating fluid container can also be designed as an SCR container or as an oil container. According to the invention, there are no restrictions in this regard.

The operating fluid container preferably has an activated carbon filter device which is fluidly connected to the operating fluid container interior by means of the vent line, so that the operating fluid container interior is fluidly connected to the atmosphere by means of the activated carbon filter device.

The electrically controllable valve is designed, for example, as a proportional valve. The electrically controllable valve is, for example, adjustable continuously between an open position and a closed position.

The electrically controllable valve can also be referred to as a first valve or as a recirculation valve.

A filling rate is to be understood as meaning a volume per unit of time that is filled into the operating fluid container interior via the filling pipe.

The method for an operating fluid container comprising a filling level sensor is preferably designed such that the determination of the filling rate is carried out using data representing the filling level of the operating fluid container, which data are provided by the filling level sensor.

The correspondingly designed method allows for a particularly simple determination of the filling rate at which the operating fluid container is filled.

The filling rate is determined, for example, by a change in a m filling volume of the operating fluid located in the operating fluid container interior per unit of time. Consequently, the filling rate indicates the filling volume per unit of time.

Preferably, the method for an operating fluid container comprising a second valve arranged in the vent line is designed such that a target degree of opening of the second valve is determined on the basis of the filling rate, and that the degree of opening of the second valve is set to the target degree of opening.

The second valve is designed, for example, as an electrically controllable valve and also, for example, as a proportional valve, and is preferably adjustable between an open position and a closed position. The second valve is continuously adjustable between the open position and the closed position, for example.

The second valve can also be referred to as a vent valve.

The method is preferably designed such that, when a filling process is detected, the second valve is set to a predetermined and for example constant degree of opening.

The method is preferably designed such that the second valve is closed when a filling stop is detected.

The object on which the present invention is based is also achieved by a method for filling an operating fluid container, wherein the operating fluid container has at least one operating fluid container interior which can be filled with an operating liquid via a filling pipe, and wherein the operating fluid container interior is fluidly connected to the filling pipe by means of a recirculation line, and wherein the operating fluid container has an electrically controllable valve which is arranged in the recirculation line and is adjustable between an open position and a closed position, and wherein the operating fluid container has a vent line which at least indirectly fluidly connects the operating fluid container interior to the atmosphere. The method comprises the following method steps:
determining a pressure inside the operating fluid container interior and/or inside the filling pipe during a filling process;
determining a target degree of opening of the electrically controllable valve on the basis of the pressure; and
setting the degree of opening of the electrically controllable valve to the target degree of opening.

The correspondingly designed method according to the invention has the advantage that the amount of air charged with gaseous components of the operating fluid that is expelled from the operating fluid container to the atmosphere or to an activated carbon filter during a filling process is reduced. This is because, by controlling the degree of opening of the electrically controllable valve, the gas volume flow expelled from the operating fluid container, which is fed from the operating fluid container interior via the recirculation line and via the filling pipe back into the operating fluid container interior, can be controlled on the basis of the pressure inside the operating fluid container interior and/or by means of the pressure inside the filling pipe such that a minimized amount of fresh ambient air is sucked into the operating fluid container via the filling pipe, and that a minimized amount of gas expelled from the operating fluid container is discharged via the vent line to the atmosphere or to an activated carbon filter which is fluidly connected to the operating fluid container interior by means of the vent line, and that an amount of gas expelled to the atmosphere via the filling pipe is minimized.

The operating fluid container is, for example, an operating fluid container to be installed in a motor vehicle. The operating fluid container can be designed, for example, as a motor vehicle tank.

Furthermore, the operating fluid container can also be designed as an SCR container or as an oil container. According to the invention, there are no restrictions in this regard.

The operating fluid container preferably has an activated carbon filter device which is fluidly connected to the operating fluid container interior by means of the vent line, so that the operating fluid container interior is fluidly connected to the atmosphere by means of the activated carbon filter device.

The electrically controllable valve is designed, for example, as a proportional valve. The electrically controllable valve is, for example, adjustable continuously between an open position and a closed position.

The electrically controllable valve can also be referred to as a first valve or as a recirculation valve.

The method is carried out, for example, using an electronic control device which is data-coupled to the electrically controllable valve via a data exchange link. The electronic control device is designed to determine a target degree of opening based on a pressure inside the operating fluid container interior and to output such a control signal to the electrically controllable valve such that the degree of opening of the electrically controllable valve is set to the target degree of opening.

For example, for an operating fluid container or for a type of operating fluid container, a target value table for the target degree of opening of the electrically controllable valve is cre-ated on the basis of the pressure, which lies in a range between a minimum pressure (e.g., 900 mbar) and a maximum pressure (e.g., 1100 mbar), using the following method:
W1 setting the pressure to the minimum pressure;
W2 filling the operating fluid container via the filling pipe at the set pressure;
W3 setting the degree of opening of the electrically controllable valve to a minimum degree of opening;
W4 measuring a gas volume flow expelled through the vent line and/or through the filling pipe and storing this gas volume flow associated with the set degree of opening;
W5 increasing the degree of opening of the electrically adjustable valve by a predetermined increase value;
W6 repeating method steps W4 and W5 until the degree of opening of the electrically adjustable valve has reached a maximum degree of opening;
W7 determining the smallest gas volume flow expelled through the vent line and/or through the filling pipe from among the gas volume flows associated with the different degrees of opening and the set pressure;
W8 storing the degree of opening which is associated with the set pressure and with the smallest gas volume flow associated with this pressure as the target degree of opening associated with the set pressure;
W9 increasing the pressure by a predetermined increase value; and
W10 repeating method steps W2 to W9 until the pressure has reached the maximum pressure.

The minimum degree of opening of the electrically controllable valve can, for example, correspond to the closed position of the electrically controllable valve.

The maximum degree of opening of the electrically controllable valve can, for example, correspond to the open position of the electrically controllable valve.

The values for the degree of opening of the electrically controllable valve can be determined from the multi-dimensional characteristic map generated by this method, which map describes the expelled gas volume flow on the basis of at least two input variables, namely the pressure and the degree of opening of the electrically controllable valve for a specific geometry of an operating fluid container; with these values, the gas volume flow expelled through the vent line is minimized.

The method is preferably designed such that, when a filling stop is detected, a method step for closing the electrically controllable valve is carried out.

Preferably, the method for an operating fluid container comprising a pressure sensor is designed such that the determination of a pressure is carried out using data representing the pressure in the operating fluid container interior of the operating fluid container, which data are provided by a pressure sensor in the operating fluid container interior, and/or using data representing the pressure in the filling pipe, which data are provided by the pressure sensor in the filling pipe.

A pressure is preferably determined during a filling process by a pressure sensor.

The pressure sensor is preferably arranged in the operating fluid container interior. The pressure sensor is also preferably attached to the top of the operating fluid container in the operating fluid container interior.

Preferably, the method for an operating fluid container comprising a second valve arranged in the vent line is designed such that a target degree of opening of the second valve is determined on the basis of the pressure, and that the degree of opening of the second valve is set to the target degree of opening.

The second valve is designed, for example, as an electrically controllable valve and also, for example, as a proportional valve, and is preferably adjustable between an open position and a closed position. The second valve is continuously adjustable between the open position and the closed position, for example.

The second valve can also be referred to as a vent valve.

The method is preferably designed such that, when a filling process is detected, the second valve is set to a predetermined and for example constant degree of opening.

The method is preferably designed such that the second valve is closed when a filling stop is detected.

In the method, a target degree of opening of the second valve is determined, for example, on the basis of the pressure in the operating fluid container interior, by retrieving values stored in data tables for the target degree of opening of the valve.

In the method, the degree of opening of the second valve is set to the target degree of opening for example using a data exchange link between a control device and the second valve, with control signals being sent from the control device to the second valve.

The second valve is again preferably designed as a non-controllable valve, again preferably as a non-return valve, tank vent valve, roll-over valve (ROV), fill-limit-vent valve (FLVV), or as a nipple.

The object on which the present invention is based is also achieved by a method for filling an operating fluid container, wherein the operating fluid container has at least one operating fluid container interior which can be filled with an operating liquid via a filling pipe, and wherein the operating fluid container interior is fluidly connected to the filling pipe by means of a recirculation line, and wherein the operating fluid container has an electrically controllable valve which is arranged in the recirculation line and is adjustable between an open position and a closed position, and wherein the operating fluid container has a vent line which at least indirectly fluidly connects the operating fluid container interior to the atmosphere. The method comprises the following method steps:
determining a gas volume flow expelled from the filling pipe during a filling process;
determining a target degree of opening of the electrically controllable valve on the basis of the gas volume flow; and
setting the degree of opening of the electrically controllable valve to the target degree of opening.

The correspondingly designed method according to the invention has the advantage that the amount of air charged with gaseous components of the operating fluid that is expelled from the operating fluid container to the atmosphere or to an activated carbon filter during a filling process is reduced. This is because, by controlling the degree of opening of the electrically controllable valve, the gas volume flow expelled from the operating fluid container, which is fed from the operating fluid container interior via the recirculation line and via the filling pipe back into the operating fluid container interior, can be controlled on the basis of the gas volume flow that is expelled from the filling pipe such that a minimized amount of fresh ambient air is sucked into the operating fluid container via the filling pipe, and that a minimized amount of gas expelled from the operating fluid container is discharged via the vent line to the atmosphere or to an activated carbon filter which is fluidly connected to the operating fluid container interior by means of the vent line, and that an amount of gas expelled to the atmosphere via the filling pipe is minimized.

The operating fluid container is, for example, an operating fluid container to be installed in a motor vehicle. The operating fluid container can be designed, for example, as a motor vehicle tank.

Furthermore, the operating fluid container can also be designed as an SCR container or as an oil container. According to the invention, there are no restrictions in this regard.

The operating fluid container preferably has an activated carbon filter device which is fluidly connected to the operating fluid container interior by means of the vent line, so that the operating fluid container interior is fluidly connected to the atmosphere by means of the activated carbon filter device.

The electrically controllable valve is designed, for example, as a proportional valve. The electrically controllable valve is, for example, adjustable continuously between an open position and a closed position.

The electrically controllable valve can also be referred to as a first valve or as a recirculation valve.

The method is carried out, for example, using an electronic control device which is data-coupled to the electrically controllable valve via a data exchange link. The electronic control device is designed to determine a target degree of opening based on a gas volume flow inside the filling pipe and to output such a control signal to the electrically controllable valve such that the degree of opening of the electrically controllable valve is set to the target degree of opening.

Preferably, the method for an operating fluid container comprising a gas flow measuring device is designed such that the determination of a gas volume flow is carried out using data which represent the gas volume flow in the filling pipe, which data are provided by the gas flow measuring device.

A gas volume flow is preferably determined during a filling process by a pressure sensor.

Preferably, the method for an operating fluid container comprising a second valve arranged in the vent line is designed such that a target degree of opening of the second valve is determined on the basis of the gas volume flow, and that the degree of opening of the second valve is set to the target degree of opening.

The second valve is designed, for example, as an electrically controllable valve and also, for example, as a proportional valve, and is preferably adjustable between an open position and a closed position. The second valve is continuously adjustable between the open position and the closed position, for example.

The second valve can also be referred to as a vent valve.

The method is preferably designed such that, when a filling process is detected, the second valve is set to a predetermined and for example constant degree of opening.

The method is preferably designed such that the second valve is closed when a filling stop is detected.

In the method, a target degree of opening of the second valve is determined, for example, on the basis of the gas volume flow in the filling pipe, by retrieving values stored in data tables for the target degree of opening of the valve.

In the method, the degree of opening of the second valve is set to the target degree of opening for example using a data exchange link between a control device and the second valve, with control signals being sent from the control device to the second valve.

The second valve is again preferably designed as a non-controllable valve, again preferably as a non-return valve, tank vent valve, roll-over valve (ROV), fill-limit-vent valve (FLVV), or as a nipple.

The method is preferably designed such that the target degree of opening of the electrically controllable valve and/or the second valve is determined and set in such a way that a gas volume flow expelled from the vent line is minimized.

The target degree of opening of the second valve is preferably determined by a method as described above.

The method is preferably designed such that the target degree of opening of the electrically controllable valve and/or the second valve is determined in such a way that a gas volume flow expelled from the filling pipe to the atmosphere is minimized.

For example, for an operating fluid container or for a type of operating fluid container, a target value table for the target degree of opening of the electrically controllable valve is cre-ated on the basis of the filling rate, which is in a range between a minimum filling rate (for example 10 liters per minute) and a maximum filling rate (for example 50 liters per minute), using the following method:
V1 setting the filling rate to the minimum filling rate;
V2 filling the operating fluid container via the filling pipe at the set filling rate;
V3 setting the degree of opening of the electrically controllable valve to a minimum degree of opening;
V4 measuring a gas volume flow expelled through the filling pipe and/or through the vent line and storing this gas volume flow associated with the set degree of opening;
V5 increasing the degree of opening of the electrically adjustable valve by a predetermined increase value;
V6 repeating method steps V4 and V5 until the degree of opening of the electrically adjustable valve has reached a maximum degree of opening;
V7 determining the smallest gas volume flow expelled through the filling pipe and/or through the vent line from among the gas volume flows associated with the different degrees of opening and the set filling rate;
V8 storing the degree of opening which is associated with the set filling rate and with the smallest gas volume flow associated with this filling rate as the target degree of opening associated with the set filling rate;
V9 increasing the filling rate by a predetermined increase value; and
V10 repeating method steps V2 to V9 until the filling rate has reached the maximum filling rate.

The set filling rate is set, for example, on a nozzle or another operating fluid dispensing device.

The minimum degree of opening of the electrically controllable valve can, for example, correspond to the closed position of the electrically controllable valve.

The maximum degree of opening of the electrically controllable valve can, for example, correspond to the open position of the electrically controllable valve.

The values for the degree of opening of the electrically controllable valve can be determined from the multi-dimensional characteristic map generated by this method, which map describes the expelled gas volume flow on the basis of at least two input variables, namely the filling rate and the degree of opening of the electrically controllable valve for a specific geometry of an operating fluid container; with these values, the gas volume flow expelled through the vent line is minimized.

The target degree of opening of the second valve is preferably determined by a method as described above.

The method is preferably designed such that the determination of a target degree of opening of the electrically controllable valve is carried out by retrieving values stored in data tables for the target degree of opening of the electrically controllable valve.

The values stored in the data tables for the target degree of opening of the electrically controllable valve are preferably determined before the filling process.

The values stored in the data tables for the target degree of opening of the electrically controllable valve are preferably determined on the basis of the geometry of the operating fluid container.

More preferably, the values stored in the data tables for the target degree of opening of the second valve are determined before the filling process.

More preferably, the values stored in the data tables for the target degree of opening of the second valve are determined on the basis of the geometry of the operating fluid container.

Furthermore, the present invention is based on the object of providing an operating fluid container which allows gases expelled from the operating fluid container to the atmosphere during a filling process of the operating fluid container to be reduced.

This object on which the present invention is based is achieved by an operating fluid container having the features of claim 10. Advantageous embodiments of the operating fluid container are described in the claims dependent on claim 10.

More precisely, this object on which the present invention is based is achieved by an operating fluid container, wherein the operating fluid container has an operating fluid container interior which can be filled with an operating liquid via a filling pipe, and wherein the operating fluid container interior is fluidly connected to the filling pipe by means of a recirculation line, and wherein the operating fluid container has an electrically controllable valve which is arranged in the recirculation line and is adjustable between an open position and a closed position, and wherein the operating fluid container has a vent line which at least indirectly fluidly connects the operating fluid container interior to the atmosphere, and wherein the operating fluid container has a filling level sensor and/or a pressure sensor which is arranged in the operating fluid container interior and/or a pressure sensor which is arranged in the filling pipe. The operating fluid container is characterized in that the operating fluid container has an electronic control device and/or an interface to an electronic control device which is designed to carry out one of the methods described above for filling an operating fluid container.

The operating fluid container according to the invention has the advantage that the amount of air charged with gaseous components of the operating fluid that is expelled from the operating fluid container to the atmosphere or to an activated carbon filter during a filling process is reduced.

As a result, an activated carbon filter device placed between the vent line and the atmosphere can be loaded with fewer hydrocarbons from the expelled gas volume, as a result of which the activated carbon filter device can be made smaller, which ultimately saves costs and weight.

The operating fluid container is, for example, an operating fluid container to be installed in a motor vehicle. The operating fluid container can be designed, for example, as a fuel tank. Furthermore, the operating fluid container can be designed as an SCR container or oil container.

The control device has at least one electrical data store. The electrical data store is designed to store and output the data table.

The operating fluid container preferably has an activated carbon filter device which is fluidly connected to the atmosphere and the operating fluid container interior via the vent line.

The filling level sensor is preferably arranged in the operating fluid container interior. The filling level sensor is also preferably attached to the underside of the operating fluid container in the operating fluid container interior.

Preferably, the operating fluid container is designed such that it has a second valve which is arranged in the vent line.

The emissions from the operating fluid container to the atmosphere and into an activated carbon filter can be further reduced by an appropriate design of the operating fluid container.

The second valve is preferably adjustable between an open position and a closed position.

The second valve is preferably continuously adjustable between an open position and a closed position.

The second valve is again preferably designed as a non-controllable valve, again preferably as a non-return valve, tank vent valve, roll-over valve (ROV), fill-limit-vent valve (FLVV), or as a simple nipple.

The operating fluid container is preferably designed such that the second valve is designed as an electrically controllable valve.

The second valve is preferably designed as a proportional valve and more preferably continuously adjustable between an open position and a closed position.

The operating fluid container is preferably designed such that the electrically controllable valve and the second valve are designed as one component.

The component is preferably designed as a directional valve. Furthermore, the directional valve is preferably designed as a 3/2-way valve.

Preferably, the operating fluid container is designed such that the second valve is designed as a non-controlled valve, the control device being designed to carry out a method according to any of claim 1-2 or 4-5 or 7-9.

The second valve is preferably designed as a non-return valve, tank vent valve, roll-over valve (ROV), fill-limit-vent valve (FLVV), or as a nipple.

Furthermore, the present invention is based on the object of providing a motor vehicle which has a reduced gas volume flow expelled during the filling process.

This object on which the present invention is based is achieved by a motor vehicle having the features of claim 15.

More precisely, this object on which the present invention is based is achieved by a motor vehicle which is characterized in that the motor vehicle has an operating fluid container as described above.

The motor vehicle is preferably designed as a hybrid vehicle. A hybrid vehicle is a vehicle that has two different energy stores that can absorb, store and release the energy required to move the vehicle. Different energy stores store energy, for example, in different states of aggregation. The hybrid vehicle preferably has a traction battery and a fuel tank.

Further advantages, details and features of the invention can be found below in the described embodiments. In the drawings, in detail:

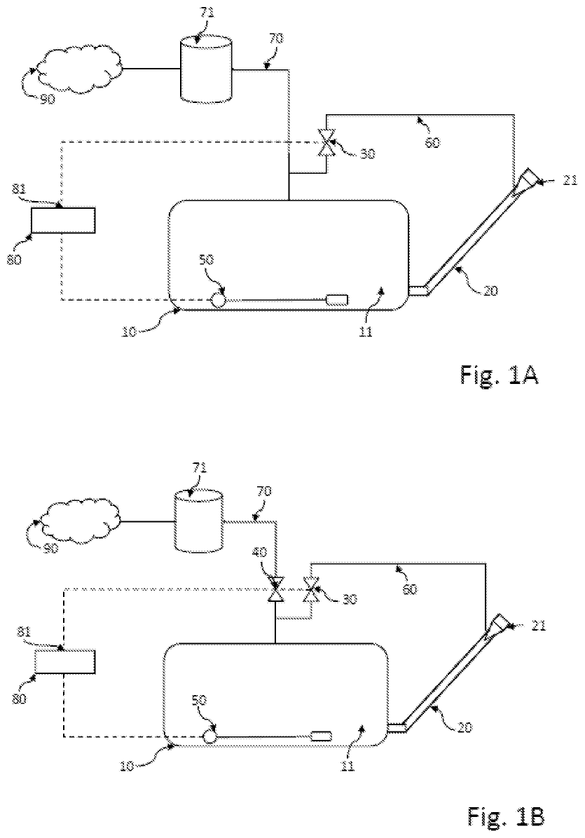

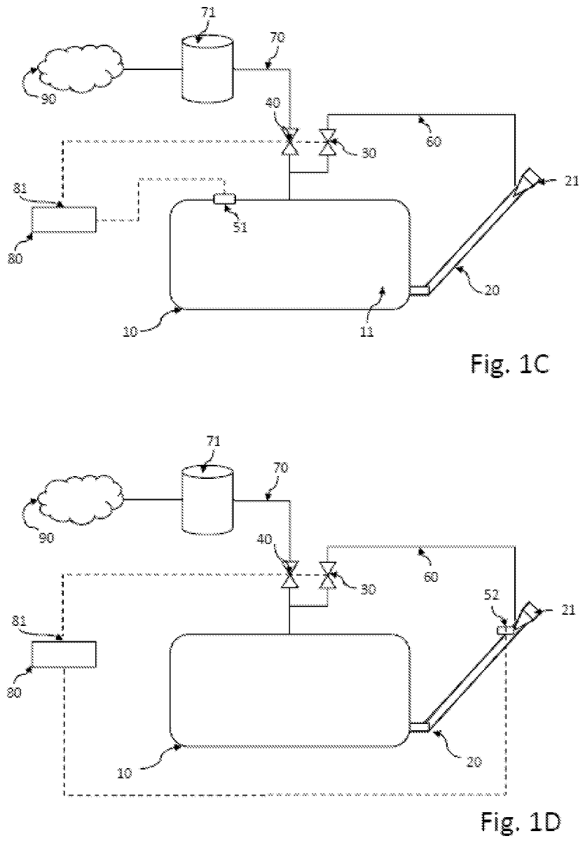

FIG. 1A: is a schematic representation of an operating fluid container according to the present invention;

FIG. 1B: is a schematic representation of an operating fluid container according to a further embodiment of the present invention;

FIG. 1C: is a schematic representation of an operating fluid container according to yet another embodiment of the present invention;

FIG. 1D: is a schematic representation of an operating fluid container according to yet another embodiment of the present invention;

FIG. 1E: is a schematic representation of an operating fluid container according to yet another embodiment of the present invention;

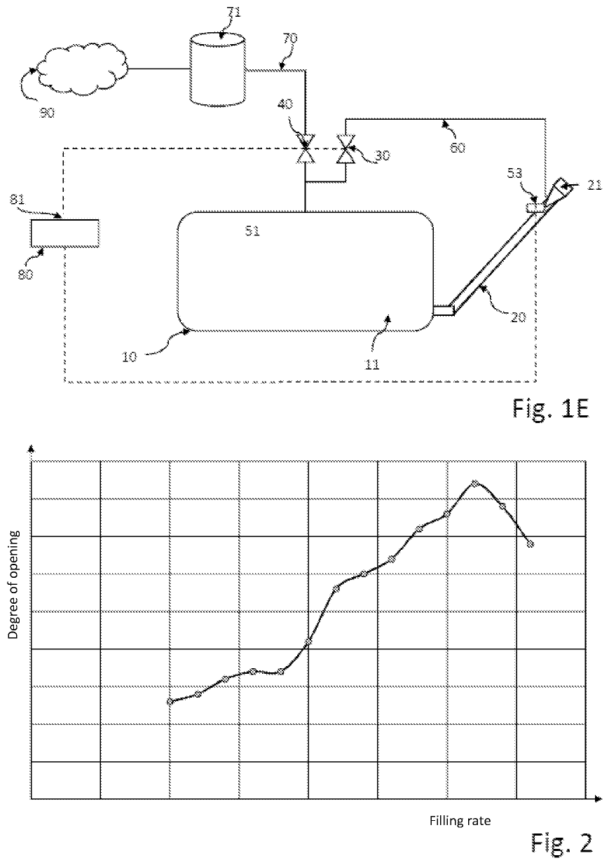

FIG. 2: is a representation of a degree of opening of a valve arranged in a recirculation line of the operating fluid container, which degree of opening depends on a filling rate of an operating fluid container;

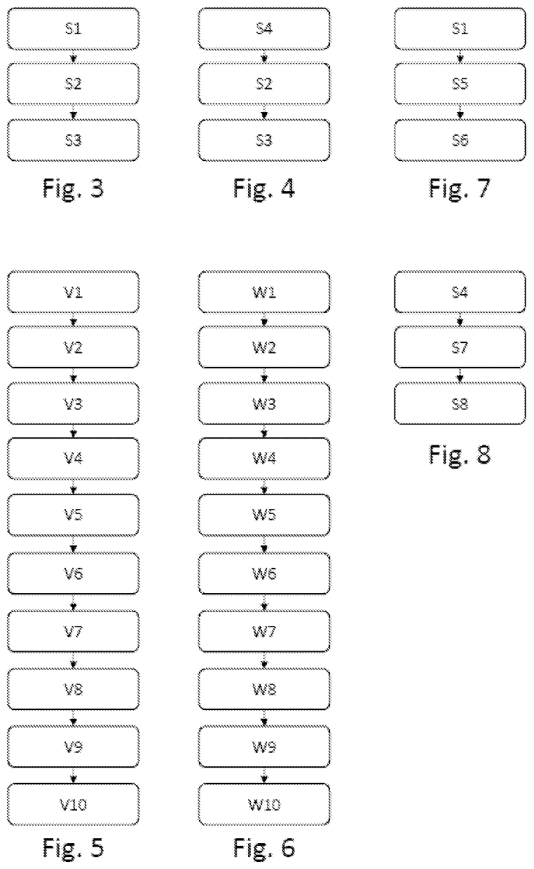

FIG. 3: is a method flowchart of a method according to the invention for filling an operating fluid container;

FIG. 4: is a method flowchart of a method according to a further embodiment of the present invention;

FIG. 5: is a method flowchart for determining the target degree of opening of a valve arranged in a recirculation line and/or a vent line of the operating fluid container, so that the gas volume flow expelled through a vent line is minimized for a particular filling rate;

FIG. 6: is a method flowchart for determining the target degree of opening of a valve arranged in a recirculation line and/or a vent line of the operating fluid container, so that the gas volume flow expelled through the vent line is minimized for a particular pressure in the operating fluid container interior;

FIG. 7: is a method flow chart for determining the degree of opening of a second valve on the basis of the filling rate, which valve is arranged in the vent line of the operating fluid container; and

FIG. 8: is a method flow chart for determining the degree of opening of a second valve on the basis of the pressure, which valve is arranged in the vent line of the operating fluid container.

In the following description, the same reference signs denote the same components or features, such that a description of a component with reference to one drawing also applies to the other drawings; this avoids repeating the description. Furthermore, individual features that have been described in connection with one embodiment can also be used separately in other embodiments.

FIG. 1A to 1E each show schematic representations of an embodiment of an operating fluid container 10 according to the invention. It can be seen from FIG. 1A to 1E that each of the operating fluid containers 10 shown in FIG. 1A to 1E has an operating fluid container interior 11. Furthermore, each of the operating fluid containers 10 shown in FIG. 1A to 1E has a filling pipe 20 which is fluidly connected to the operating fluid container interior 11. Each of the operating fluid containers 10 shown in FIG. 1A to 1E can be filled with an operating fluid by inserting a filling device (for example a nozzle of a fuel pump; not shown in the figures) into a filling neck 21 of the filling pipe 20.

Furthermore, each of the operating fluid containers 10 shown in FIG. 1A to 1E has a recirculation line 60 which fluidly connects the operating fluid container interior 11 to the filling pipe 20. Furthermore, each of the operating fluid containers 10 shown in FIG. 1A to 1EC has an electrically controllable valve 30 which is arranged in the recirculation line 60 between the operating fluid container interior 11 and the filling pipe 20. Furthermore, each of the operating fluid containers 10 shown in FIG. 1A to 1E has a vent line 70 which indirectly fluidly connects the operating fluid container 10 to the atmosphere 90.

It can also be seen from FIG. 1A to 1E that each of the operating fluid containers 10 has an activated carbon filter device 71 via which the operating fluid container interior 11 is indirectly fluidly connected to the atmosphere 90 via the vent line 70. The activated carbon filter device 70 is not a necessary device, and therefore the operating fluid container interior 11 could also be fluidly connected directly to the atmosphere 90 via the vent line 70.

The operating fluid containers 10 shown in FIGS. 1A and 1B each have a filling level sensor 50 which is arranged in the operating fluid container interior 11. In the embodiments shown, the filling level sensor 50 is designed as a lever sensor 50. However, the present invention is not restricted to a corresponding configuration of the filling level sensor 50. The filling level sensor can be designed in any way, for example as an ultrasonic sensor or as an optical sensor, etc.

The operating fluid container 10 shown in FIG. 1A has a control device 80 which is connected to the filling level sensor 50 and the electrically controllable valve 30 via interfaces 81.

When the operating fluid container 10 shown in FIG. 1A to 1E is filled with an operating fluid, a gas volume flow is expelled from the operating fluid container interior 11 via the recirculation line 60 and another gas volume flow is expelled via the vent line 70.

In the operating fluid containers 10 shown in FIGS. 1A and 1B, the gas volume flow expelled via the recirculation line 60 and the gas volume flow expelled via the vent line 70 are influenced by a method shown in the method flowchart in FIG. 3. First, in a step S1, a filling rate is determined on the basis of data representing the filling level of the operating fluid container 10, which data are determined by the filling level sensor 50. In a step S2, a target degree of opening of the electrically controllable valve 30 is determined on the basis of the filling rate determined in this way. Thereafter, in a step S3, the degree of opening of the electrically controllable valve 30 is set to the determined target degree of opening.

This method is carried out, for example, using an electronic control device 80 which is data-coupled to the electrically controllable valve 30 via a data exchange link. The electronic control device 80 is designed to determine a target degree of opening based on a filling rate at which the operating fluid container 10 is filled with an operating fluid and to output a corresponding control signal to the electrically controllable valve 30 so that the degree of opening of the electrically controllable valve 30 is set to the target degree of opening.

The determination of the target degree of opening on the basis of the filling rate in step S2 is carried out using a characteristic map as shown schematically in FIG. 2. For this purpose, the characteristic map shown in FIG. 2 is stored in the electronic control unit 80 in the form of target value tables. The target degree of opening is determined in such a way that the gas volume flow expelled through the vent line is minimized.

In more detail, the method flow chart shown in FIG. 5 shows a method for determining a target value table or a characteristic map for the target degree of opening of an electrically controllable valve 30 on the basis of the filling rate. The filling rate can be in a range between a minimum filling rate (for example 10 liters per minute) and a maximum filling rate (for example 50 liters per minute).

In a step V1, the filling rate is set to the minimum filling rate. In a step V2, the operating fluid container 10 is filled with operating fluid via the filling pipe 20 at the set filling rate. In a step V3, the degree of opening of the electrically controllable valve 30 is set to the minimum degree of opening. Then, in a step V4, the gas volume flow expelled through the filling pipe 20 and/or the vent line 70 is measured and stored in such a way that the value of the expelled gas volume flow is associated with the degree of opening and the filling rate. In a method step V5, the degree of opening of the electrically controllable valve 30 is increased by a predetermined increase value. In a step V6, method steps V4 and V5 are repeated until the degree of opening of the electrically controllable valve 30 has reached a maximum degree of opening. In a step V7, the smallest gas volume flow expelled through the filling pipe 21 and/or through the vent line 70 is determined from among the gas volume flows associated with the different degrees of opening and the set filling rate. In a step V8, the degree of opening which is associated with the set filling rate and with the smallest gas volume flow associated with this filling rate is stored as the target degree of opening associated with the set filling rate. In a step V9, the filling rate is increased by a predetermined increase value. In a last method step V10, method steps V2 to V9 are repeated until the maximum filling rate is reached.

The target degrees of opening determined in this way each have a minimum gas volume flow expelled through the filling pipe 20 and/or through the vent line 70 for a given filling rate.

The operating fluid container 10 shown in FIG. 1B has the same structure as the operating fluid container 10 shown in FIG. 1A, and therefore reference is made to the corresponding description above. The operating fluid container 10 shown in FIG. 1B also has a second valve 40 which is arranged in the vent line 70 between the operating fluid container interior 70 and the atmosphere 90. The control device 80 is connected to the second valve 40 via a data exchange link.

The second valve 40 can be designed as a passive valve, for example in the form of a nipple or a roll-over valve or the like. In the embodiment shown in FIG. 1B, the second valve 40 is designed as an electrically controllable valve. The degree of opening of the second valve 40 is then preferably determined using the method shown in the flowchart in FIG. 7. First, in step S1, a filling rate is determined on the basis of data representing the filling level of the operating fluid container, which data are determined by the filling level sensor 50. In step S5, a target degree of opening of the second valve 40 is determined on the basis of the filling rate determined in this way. Thereafter, in step S6, the opening degree of the second valve 40 is set to the determined target degree of opening.

Method steps S2 and S3, which are described above with reference to FIG. 3, are optionally carried out before step S5.

The method as shown in FIG. 7 is carried out, for example, using the electronic control device 80 which is data-coupled to the second valve 40 via a data exchange link. The electronic control device 80 is designed to determine a target degree of opening based on a filling rate at which the operating fluid container 10 is filled with an operating fluid and to output such a control signal to the second valve 40 so that the degree of opening of the second valve 40 is set to the target degree of opening. The target degree of opening is determined in such a way that the gas volume flow expelled through the vent line 70 and/or through the filling pipe 20 is minimized.

The operating fluid containers 10 shown in FIGS. 1C and 1D each have the same structure as the operating fluid container 10 shown in FIG. 1B, and therefore reference is made to the above description of FIG. 1B. In contrast to the operating fluid container 10 shown in FIG. 1B, the operating fluid containers 10 shown in FIGS. 1C and 1D have, in the case of the operating fluid container 10 shown in FIG. 1C, a pressure sensor 51 instead of the filling level sensor 50, which pressure sensor is arranged in the operating fluid container interior 11, and have, in the case of the operating fluid container 10 shown in FIG. 1D, a pressure sensor 52 which is arranged in the filling pipe 20.

Although not shown in FIGS. 1C and 1D, the operating fluid container can also have a pressure sensor 51 in the operating fluid container interior 11 in addition to the pressure sensor 52 arranged in the filling pipe 20.

The control device 80 is connected to the pressure sensor 51 and/or the pressure sensor 52, the electrically controllable valve 30 and the second valve 40 via a data exchange link.

If the operating fluid containers 10 shown in FIGS. 1C and 1D are filled with an operating fluid by inserting a filling device (for example a nozzle of a fuel pump; not shown in the figures) into a filling neck 21 of the filling pipe 20, a gas volume flow is expelled from the operating fluid container interior 11 via the recirculation line 60 and another gas volume flow is expelled via the vent line 70.

The gas volume flow expelled via the recirculation line 60 and the gas volume flow expelled via the vent line 70 are influenced by the method shown in the flowchart in FIG. 4. First, in step S4, a pressure inside the operating fluid container interior 11 and/or inside the filling pipe 20 is determined on the basis of data representing the pressure inside the operating fluid container interior 11 and/or inside the filling pipe 20, which data are determined by the pressure sensor 51 and/or the pressure sensor 52. In step S2, a target degree of opening of the electrically controllable valve 30 is determined on the basis of the pressure determined in this way. Thereafter, in step S3, the degree of opening of the electrically controllable valve 30 is set to the determined target degree of opening.

The method as shown in FIG. 4 is carried out using the electronic control device 80 which is data-coupled to the electrically controllable valve 30 via a data exchange link. The electronic control device 80 is designed to determine a target degree of opening based on a pressure inside the operating fluid container interior 11 and/or based on a pressure inside the filling pipe 20 while the operating fluid container 10 is being filled, and to output such a control signal to the electrically controllable valve 30 so that the degree of opening of the electrically controllable valve 30 is set to the target degree of opening.

The target degree of opening is determined on the basis of the pressure in step S2 using a characteristic map, the characteristic map being stored in the electronic control unit 80 in the form of target value tables. The target degree of opening is n determined in such a way that the gas volume flow expelled through the vent line 70 and/or through the filling pipe 20 is minimized.

FIG. 6 shows a method flowchart for determining a target value table for the target degree of opening of the electrically controllable valve 30 on the basis of the pressure in the operating fluid container interior 11 and/or on the basis of the pressure within the filling pipe 20, which is/are in a range between a minimum pressure (e.g., 900 mbar) and a maximum pressure (e.g., 1100 mbar).

In a step W1, the pressure is set to the minimum pressure. In a step W2, the operating fluid container 10 is filled with operating fluid via the filling pipe 20 at the set pressure. In a step W3, the degree of opening of the electrically controllable valve 30 is set to the minimum degree of opening. Then, in a step W4, the gas volume flow expelled through the vent line 70 and/or the filling pipe 20 is measured and stored in such a way that the value of the expelled gas volume flow is associated with the degree of opening and the pressure. In a method step W5, the degree of opening of the electrically controllable valve 30 is increased by a predetermined increase value. In a step W6, method steps W4 and W5 are repeated until the degree of opening of the electrically controllable valve 30 has reached a maximum degree of opening. In a step W7, the smallest gas volume flow expelled through the vent line 70 and/or through the filling pipe 20 is determined from among the gas volume flows associated with the different degrees of opening and the set pressure. In a step W8, the degree of opening which is associated with the set pressure and with the smallest gas volume flow associated with this pressure is stored as the target degree of opening associated with the set pressure. In a step W9, the pressure is increased by a predetermined increase value. In a last method step W10, method steps W2 to W9 are repeated until the maximum pressure is reached. The target degrees of opening determined in this way each have a minimum gas volume flow expelled through the vent line 70 and/or through the filling pipe 20 for a given pressure.

The second valve 40 is designed as an electrically controllable valve. The degree of opening of the second valve 40 is determined using the method shown in the flowchart in FIG. 8. First, in step S4, a pressure is determined on the basis of the pressure in the operating fluid container interior 11 and/or on the basis of data representing the pressure inside the filling pipe 20 of the operating fluid container 10, which data are determined by the pressure sensor 51 and/or the pressure sensor 52. In step S7, a target degree of opening of the second valve 40 is determined on the basis of the pressure determined in this way. Thereafter, in step S8, the degree of opening of the second valve 40 is set to the determined target degree of opening.

Steps S2 and S3, which are described above with reference to FIG. 4, can optionally also be carried out before step S7.

The method is carried out using the electronic control device 80 which is data-coupled to the second valve 40 via a data exchange link and an interface 81. The electronic control device 80 is designed to determine a target degree of opening based on a pressure in the operating fluid container interior 11 and/or based on a pressure in the filling pipe 20 and to output such a control signal to the second valve 40 so that the degree of opening of the second valve 40 is set to the target degree of opening. The target degree of opening is determined in such a way that the gas volume flow expelled through the vent line 70 and/or through the filling pipe 20 is minimized.

The operating fluid container 10 shown in FIG. 1E has the same structure as the operating fluid container 10 shown in FIG. 1B, and therefore reference is made to the above description of FIG. 1B. In contrast to the operating fluid container 10 shown in FIG. 1B, the operating fluid container 10 shown in FIG. 1E has a gas flow measuring device 53 instead of the filling level sensor 50, which gas flow measuring device is arranged in the filling pipe 20 and is designed to determine a gas flow through the filling pipe 20.

The control device 80 is connected to the gas flow measuring device 53, the electrically controllable valve 30 and the second valve 40 via a data exchange link.

If the operating fluid container 10 shown in FIG. 1E is filled with an operating fluid by inserting a filling device (for example a nozzle of a fuel pump; not shown in the figures) into a filling neck 21 of the filling pipe 20, a gas volume flow is M expelled from the operating fluid container interior 11 via the recirculation line 60 and another gas volume flow is expelled via the vent line 70.

The gas volume flow expelled via the recirculation line 60 and the gas volume flow expelled via the vent line 70 are influenced by a control method. First, in a method step, a gas flow through the filling pipe 20 is determined using the gas flow measuring device 53. In a further method step, a target degree of opening of the electrically controllable valve 30 is determined on the basis of the gas flow determined in this way. Then, in a further method step, the degree of opening of the electrically controllable valve 30 is set to the determined target degree of opening.

This method is carried out using the electronic control device 80 which is data-coupled to the electrically controllable valve 30 via a data exchange link. The electronic control device 80 is designed to determine a target degree of opening based on a gas flow through the filling pipe 20 while the operating fluid container 10 is being filled, and to output such a control signal to the electrically controllable valve 30, so that the degree of opening of the electrically controllable valve 30 is set to the target degree of opening.

The target degree of opening is determined on the basis of the pressure in step S2 using a characteristic map, the characteristic map being stored in the electronic control unit 80 in the form of target value tables. The target degree of opening is determined in such a way that the gas volume flow expelled through the vent line 70 and/or through the filling pipe 20 is minimized.

The second valve 40 is designed as an electrically controllable valve. The degree of opening of the second valve 40 is set through a control method. First, in a method step, a gas flow in the filling pipe 20 is determined. In a further method step, a target degree of opening of the second valve 40 is determined on the basis of the gas flow determined in this way. Then, in a further method step, the degree of opening of the second valve 40 is set to the determined target degree of opening.

Steps S2 and S3, which are described above with reference to FIG. 4, can optionally also be carried out before step S7.

The method is carried out using the electronic control device 80 which is data-coupled to the second valve 40 via a data exchange link and an interface 81. The electronic control device 80 is designed to determine a target degree of opening based on a gas flow in the filling pipe 20 and to output such a control signal to the second valve 40 so that the degree of opening of the second valve 40 is set to the target degree of opening. The target degree of opening is determined in such a way that the gas volume flow expelled through the vent line 70 and/or through the filling pipe 20 is minimized.

### LIST OF REFERENCE SIGNS

10 Operating fluid container
11 Operating fluid container interior
20 Filling pipe
21 Filling neck
30 Electrically controllable valve
40 Second valve
50 Filling level sensor
51 Pressure sensor
52 Pressure sensor
53 Gas flow measuring device
60 Recirculation line
70 Vent line
71 Activated carbon filter device
80 Control device
81 Interface
90 Atmosphere

1. A method for filling an operating fluid container, the operating fluid container having:
an operating fluid container interior for filling with an operating fluid via a filling pipe, the operating fluid container interior being fluidly connected to the filling pipe via a recirculation line;
an electrically controllable valve which is arranged in the recirculation line and is adjustable between an open position and a closed position; and
the operating fluid container has a vent line which at least indirectly fluidly connects the operating fluid container interior to the atmosphere,
the method comprising steps of:
determining a filling rate during a filling process of the operating fluid container;
determining a target degree of opening of the electrically controllable valve based on the filling rate; and
setting a degree of opening of the electrically controllable valve to the target degree of opening.

2. The method according to claim 1, the operating fluid container having a filling level sensor in the operating fluid container interior, wherein the determination of the filling rate is carried out using data representing the filling level of the operating fluid container, which data are provided by the filling level sensor.

3. The method according to claim 1, wherein the operating fluid container further has a second valve which is arranged in the vent line, and
wherein the method further comprises steps of:
determining the target degree of opening of the second valve based on the filling rate; and
setting the degree of opening of the second valve to the target degree of opening.

4. A method for filling an operating fluid container, the operating fluid container having:
an operating fluid container interior for filling with an operating fluid via a filling pipe, the operating fluid container interior being fluidly connected to the filling pipe via a recirculation line;
an electrically controllable valve which is arranged in the recirculation line and is adjustable between an open position and a closed position; and
a vent line which at least indirectly fluidly connects the operating fluid container interior to the atmosphere,
the method comprising steps of:
determining a pressure inside the operating fluid container interior and/or inside the filling pipe during a filling process;
determining a target degree of opening of the electrically controllable valve based on the pressure; and
setting a degree of opening of the electrically controllable valve to the target degree of opening.

5. The method according to claim 4, wherein the operating fluid container has a pressure sensor in the operating fluid container interior and/or a pressure sensor in the filling pipe, and
wherein the determination of a pressure is carried out using data representing the pressure in the operating fluid container interior of the operating fluid container, which data are provided by the pressure sensor, and/or using data representing the pressure in the filling pipe, which data are provided by the pressure sensor.

6. The method according to claim 4,
wherein the operating fluid container has a second valve which is arranged in the vent line, and
wherein the method further includes steps of:
determining a target degree of opening of the second valve based on the pressure; and
setting the degree of opening of the second valve to the target degree of opening.

7. A method for filling an operating fluid container, the operating fluid container having:
an operating fluid container interior for filling with an operating fluid via a filling pipe, the operating fluid container interior being fluidly connected to the filling pipe via a recirculation line;
an electrically controllable valve which is arranged in the recirculation line and is adjustable between an open position and a closed position; and
a vent line which at least indirectly fluidly connects the operating fluid container interior to the atmosphere,
the method comprising steps of:
determining a gas volume flow expelled from the filling pipe during a filling process;
determining a target degree of opening of the electrically controllable valve based on the gas volume flow; and
setting a degree of opening of the electrically controllable valve to the target degree of opening.

8. The method according to claim 7, wherein that the target degree of opening of the electrically controllable valve and/or the second valve is determined and set in such a way that a gas volume flow expelled from the vent line is minimized.

9. The method according to claim 7, wherein the target degree of opening of the electrically controllable valve and/or the second valve is determined in such a way that the gas volume flow expelled from the filling pipe to the atmosphere is minimized.

10. The method according to claim 7, wherein the determination of the target degree of opening of the electrically controllable valve is carried out by retrieving values stored in data tables for the target degree of opening of the electrically controllable valve.

11-16. (canceled)
